(19) United States
(12) Patent Application Publication
(10) Pub. No.: US 2010/0012876 A1
(43) Pub. Date: Jan. 21, 2010

(54) Adapter for gas fireplace valves

(76) Inventor: Derek W. M. Burger, Goleta, CA (US)

Correspondence Address: Derek Burger, P.O. Box 80007, Goleta, CA, 93118, US

(21) Appl. No.: 12/460,533

(22) Filed: Jul. 20, 2009

Related U.S. Application Data
(60) Provisional application No. 61/135,392, filed on Jul. 21, 2008.

(51) Int. Cl. F16K 31/44; B23P 11/00; F16B 13/00

(52) U.S. Cl. 251/264; 29/428; 285/137.11

(57) ABSTRACT

An adapter for gas valves used for fireplaces and barbecues. The adapter bridges a distance between the gas valve and a finishing flange used to cover a hole in a floor or wall within which the gas valve T-junction is recessed. The adapter includes an inner length with female threading adapted to mate with the male threading on a valve control leg of the gas valve T-junction, and an outer length with male threading adapted to mate with the female threading on the finishing flange. The threading on the gas valve T-junction, adapter, and finishing flange is all parallel enabling maximum axial adjustment therebetween, and eliminating the need for expensive plumbing work to couple pipe elements with tapered threading therebetween. Multiple adapters may be coupled together to bridge longer distances. A gas key having an adjustable length couples with the adapter to provide fine length adjustment. The adapter may be a machined metal tube or a molded plastic element. Methods of retrofitting gas valves are disclosed for adapting the gas valve to the modification of the wall or floor thickness. Typically, a wall is added which recesses the gas valve farther than can be reached by standard finishing flanges, necessitating a retrofit with the adapter.

### RELATED APPLICATIONS

The present application claims priority from U.S. Provisional Application Ser. No. 61/135,392, filed Jul. 21, 2008.

### FIELD OF THE INVENTION

The present invention generally relates to adapters for gas valves, and more particularly to an extension adapter for a gas fireplace or barbecue valve.

### BACKGROUND OF THE INVENTION

Many modern fireplaces now utilize gas to provide a flame or use gas to assist in lighting real firewood. Common to both is a source of natural gas or LP gas which is piped within proximity of the hearth of the fireplace. Typically, the gas source is controlled by a regulating valve near the fireplace. Downstream of the shut-off valve, accessories such as log lighter burner pipes or air-gas mixing chambers may be installed to condition the flow of gas out into the fireplace and to distribute the gas such that an optimal flame may be burned. Such gas supply systems are also used in other applications, most notably for barbeques.

Most gas shut-off valves include a T-junction with a gas inlet, a gas outlet, and a leg having a stem with which a gas valve key interfaces. For example, the stem most commonly has a square cross section, while the gas valve key normally has a square receiving socket adapted to receive the stem. A handle with wings on the key provides leverage so that the operator can easily rotate the key.

Typically, the gas shut-off valve is positioned near the fireplace. For instance, sometimes the gas shut-off valve and connected gas pipes may be routed underneath the floor of the dwelling. In this case, the valve stem leg of the T-junction either protrudes directly out of the floor, or it may be recessed underneath the floor. It is safer to have the gas valve stem recessed out of harms way so that it does not inadvertently get damaged. Other times the gas shut-off valve and affiliated gas pipes are routed within the walls of the dwelling. In this case, the gas valve stem is most often recessed into the wall.

In the circumstances when the gas valve is recessed either in the floor or wall, it is common practice to use a finishing flange to provide aesthetic finishing over the hole in the floor or wall. The finishing flange includes an axial tubular section with parallel internal threads that mates with parallel male threads on the gas valve junction, and a radial flange exposed on the exterior of the floor or wall to cover the hole therein. Parallel threads have a constant diameter, and are also abbreviated as BSPP (British Standard Pipe Thread Parallel). In contrast, Tapered threads have a diameter increases or decreases along the length of the thread, and are also known as BSPT (British Standard Pipe Thread Taper). Parallel threads are most common and used in bolts, screws, etc. Tapered threads are in a family of standard screw thread types that has been adopted internationally for interconnecting and sealing pipe ends by mating an external (male) with an internal (female) thread. Parallel threads are used between the gas valve junction and finishing flange to permit adjustment of the axial position of the flange depending on the distance to which the junction is recessed.

A common problem occurs when the distance between the gas valve and the face of the floor or wall changes. That is, the axial tubular section of the finishing flange permits some adjustment, but must be long enough to couple with the valve junction threads. If a new floor is added, or sheet rock added to a wall around the fireplace, for example, the axial distance from the face of the floor or wall and gas valve increases, possibly rendering the existing finishing flange too short. The actuating key may also be too short, though fireplace and household supply stores typically carry both short and long keys. However they do not carry multiple lengths of finishing flanges, and a retrofit by a plumber is then required. The retrofit involves much effort and not a small expense to add a tubular extension the proper distance so that the finishing flange can be installed at the proper position flush against the floor or wall. Compounding the difficulty, standard pipe tubing used to bridge the distance between the gas valve and the finishing flange has tapered threads, and is not sold with both male and female ends. A male-male pipe connected to a female-female sleeve is required. And because the two thread systems do not cleanly mesh, the extension length can only be tightened onto the valve junction, and the finishing flange onto the extension length, within a very short linear range. That makes sizing of any intervening female-male pipe extension very specific.

It would be beneficial to provide an adapter that enables simple retrofitting of existing fireplace gas valves when a new floor or wall is added.

### SUMMARY OF THE INVENTION

In accordance with one aspect of the present invention, a gas valve assembly comprises a gas valve, a finishing flange, and an adapter therebetween. The gas valve includes a valve control leg with male threading and a control stem passing therethrough. The finishing flange having an axial extension with female threading. The adapter includes an inner length with female threading adapted to mate with the male threading on a valve control leg, and an outer length with male reading adapted to mate with the female threading on the finishing flange. The gas valve assembly may form a part of a larger fireplace gas supply system. Preferably, the male threading on the valve control leg, the female threading on the finishing flange, the female threading on the adapter inner length and the male threading on the adapter outer length are all parallel threading. The adapter may be made of brass, aluminum, stainless steel, or other suitable metal. Alternatively, the adapter may be made of a suitably rigid plastic, or other similar expedient.

in a preferred embodiment, the outer length is greater in axial dimension than the inner length. The total axial dimension of the adapter may vary, but in an exemplary embodiment is about 6 inches, in which case the axial dimension of the inner length is desirably between about 1-2 inches.

A method of retrofitting a gas valve is also provided by the present invention. The method includes threading an adapter having female parallel threading onto the male parallel threading of a gas control leg of the gas valve, and threading a finishing flange having female parallel threading onto male parallel threading of an outer length of the adapter.

In accordance with a further aspect of the present invention, a method of adding to a wall or floor adjacent to a fireplace having a gas supply system is disclosed. A new wall or floor is constructed over the existing wall or floor. The method includes forming a hole in the new wall or floor at the location of a hole in the existing wall or floor within which is recessed a gas control leg of a gas valve. An adapter having female parallel threading is threaded onto the male parallel threading of the gas control leg of the gas valve. A finishing flange having female parallel threading is threaded onto male parallel threading of an outer length of the adapter.

A further understanding of the nature and advantages of the present invention are set forth in the following description and claims, particularly when considered in conjunction with the accompanying drawings in which like parts bear like reference numerals.

### BRIEF DESCRIPTION OF THE DRAWINGS

The invention will now be explained and other advantages and features will appear with reference to the accompanying schematic drawings wherein:

FIG. 1 is a partially cut-away elevational view of a conventional assembly of a finishing flange to a gas valve junction of the prior art;

FIG. 2 is a partially cut-away elevational view of an assembly of a finishing flange connected to a gas valve junction via an adapter of the present invention to accommodate an intervening wall or floor;

FIG. 3 is a schematic view of an assembly of a finishing flange connected to a gas valve junction via a series of adapters of the present invention;

FIG. 4 is a cut-away perspective view of a gas valve adapter of the present invention;

FIG. 5 is an elevational view of the gas valve adapter of FIG. 4;

FIG. 6 is a longitudinal sectional view of the gas valve adapter of FIG. 5;

FIG. 7 is a perspective view of an exemplary adjustable key that controls a gas valve junction disclosed herein;

FIG. 8 is a partially sectioned elevational view of the exemplary adjustable key; and

FIG. 9 is a perspective view of an ornamental handle for the adjustable key of FIGS. 7 and 8.

### DETAILED DESCRIPTION OF THE PREFERRED EMBODIMENTS

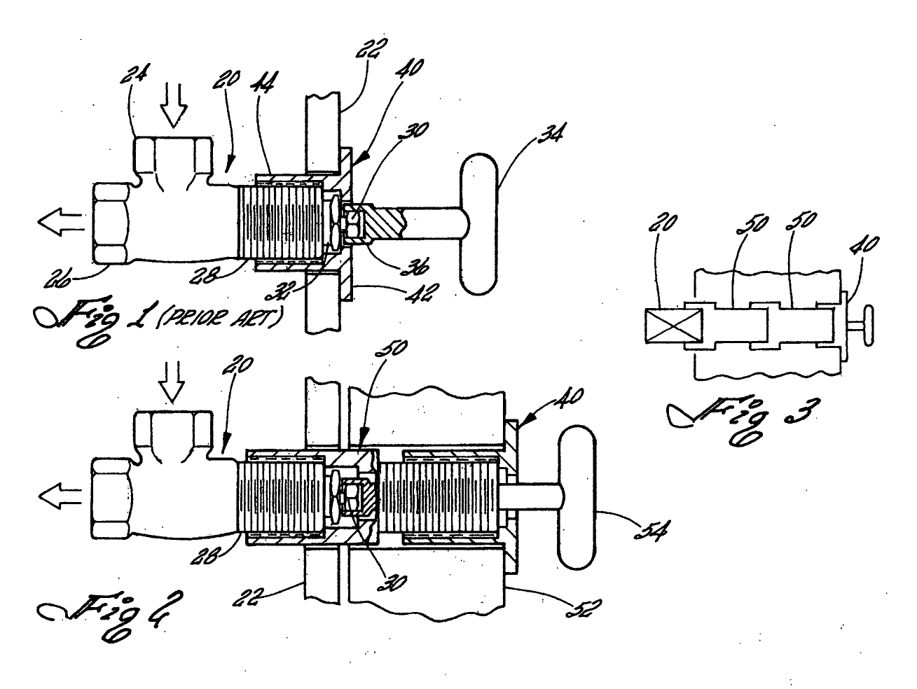

The present invention provides an adapter that extends between a finishing flange and a fireplace gas valve junction. An existing assembly without the adapter is seen in FIG. 1. A gas valve is housed within a T-junction 20 that is recessed behind a wall 22, or a floor in other configurations. The gas valve includes an inlet leg 24, an outlet leg 26, and a valve control leg 28 that has male threading. A stem having a square head 30 projects from valve control apparatus 32 extending through the leg 28. A gas key 34 includes a female end 36 that couples to and enables rotation of the square head 30. The square head 30 either projects or is visible through a hole (not numbered) in the wall 22 which is then covered by a finishing flange 40. The finishing flange 40 includes a circular flange portion 42 and covers the hole in the wall, and an axial tubular section 44 having internal threads that mate with the male threading on the valve control leg 28. As indicated above, the male-female threading on the leg 28 and tubular section 44 is parallel to enable full axial adjustment of the flange 40.

FIG. 2 illustrates an assembly utilizing an adapter 50 of the present invention, in which like parts will be given like numbers. In this configuration, a new wall 52 such as a decorative stone has been added over the existing wall 22 such that the square head 30 on the valve stem is significantly recessed. As mentioned above, a longer key 54 may be required, though engaging the female end with the recessed valve stem may be problematic. In addition, to properly couple the finishing flange 40 to the valve junction 20, an extension therebetween must be provided.

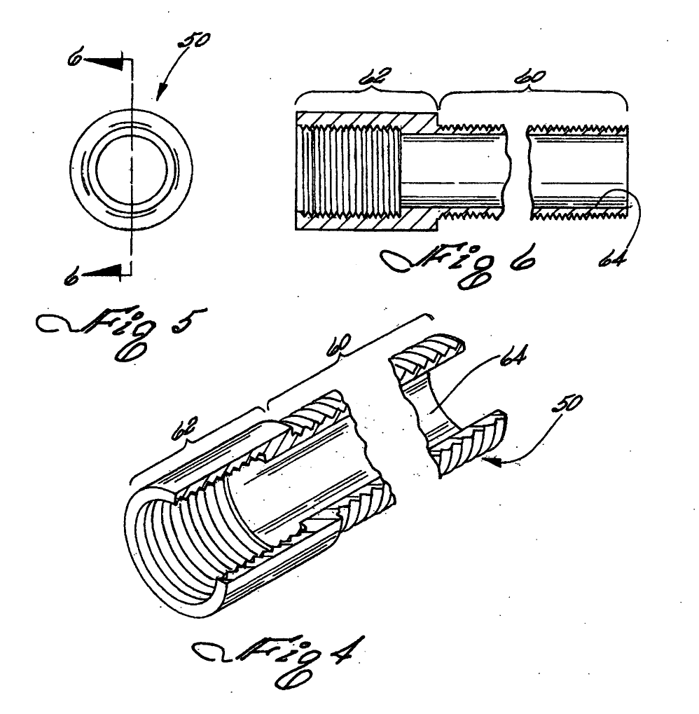

The adapter 50 of the present invention is more clearly shown in FIGS. 4-6, and includes an outer length 60 having parallel male threading, and an inner length 62 having parallel female threading. The male threading on the outer length 60 mates with the male threading on the finishing flange 40, while the female threading on the inner length 62 mates with the male threading on the valve control leg 28 of the junction 20. The adapter 50 has a length sufficient to bridge the gap between the junction 20 and the finishing flange 40, and also enables axial adjustment of the position of the finishing flange 40. An inner bore 64 of the adapter 50 helps guide the female end of the gas key 54 into engagement with the square head 30 of the gas valve stem.

In an exemplary embodiment, the inner length 62 has an axial dimension of between about 1-2 inches, and preferably has parallel female threading of at least 1 inch. The outer length 60 has an axial dimension of between 4-6 inches, preferably about 5 inches, with the male threading thereon extending the entire dimension. The total length of the adapter 50 may be variable, though a useful length is about 6 inches. In other words, the outer length 60 has a greater dimension than the inner length 62, primarily to enable wide adjustment of the position of the finishing flange 40 thereon.

Desirably, the adapters 50 of the present invention are made of a suitable metal such as brass, aluminum, stainless steel, or others, but may also be made of plastic or any suitably rigid material. The adapters could also be sold in conjunction with the finishing flanges in a package for greater versatility.

FIG. 3 illustrates two adapters 50 coupled in series to bridge a greater distance between the gas valve junction 20 and finishing flange 40. Any number of adapters 50 could be utilized in standard lengths to bridge even very large distances, or the adapters 50 of the present invention may be provided in a variety of lengths.

The availability of the adapters 50 of the present invention greatly facilitates the task of retrofitting a gas valve when a new floor or wall has been installed. Rather than hiring a plumber to do extensive pipe fitting, sometimes requiring access into wall spaces or subfloors, the contractor merely needs to purchase one or more of the adapters. A hole in the new wall or floor large enough for the adapters is created, after which the adapter is inserted through the hole and threaded onto the valve control leg 28 of the valve junction 20. Thereafter the finishing flange 40 screws onto the adapter 50. Because of the parallel threading, a large amount of axial adjustment is possible.

As mentioned above, certain problems occur when the distance between the gas valve and the face of the floor or wall changes. Even when the adapters of the present invention are utilized, however, a proper sized gas key will also be required, though fireplace and household supply stores typically carry only two sizes—short and long keys.

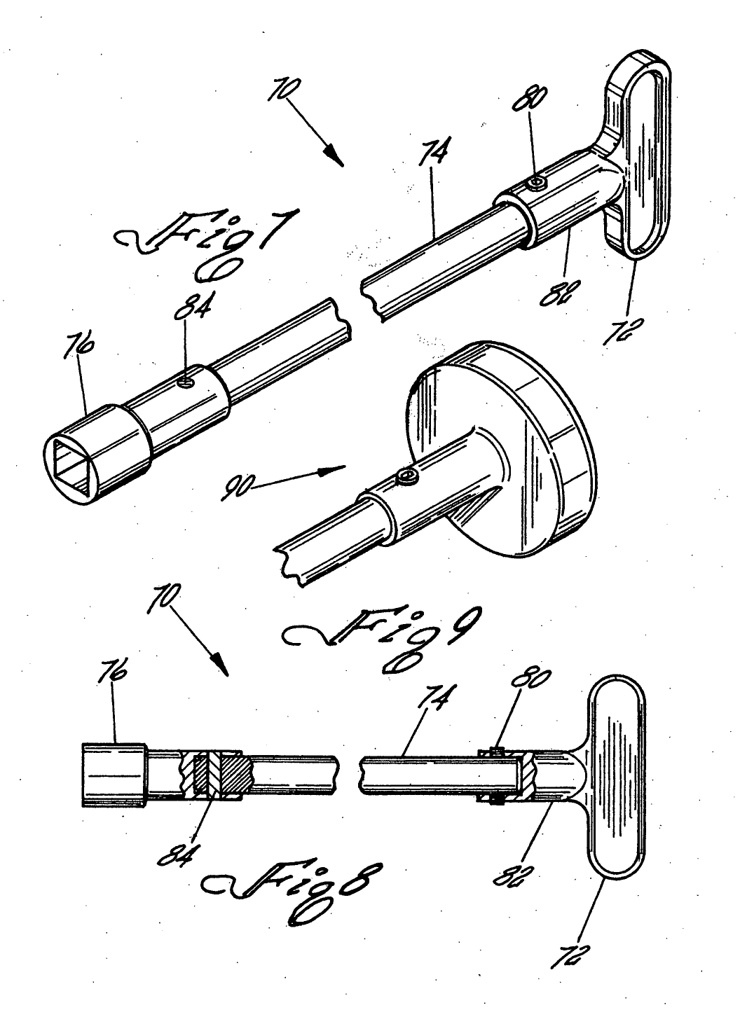

To solve this issue, FIGS. 7 and 8 illustrate an exemplary adjustable key 70 that can be used to control a gas valve junction by engaging a square head 30 (FIG. 2), for example. More specifically, the key 70 includes a handle 72, a shaft, 74, and a female end 76 that mates with the square head 30 to control the gas valve.

There are a number of ways to make the length of the key 70 adjustable, including loosening a set screw 80 in the handle 72 and moving the handle along the shaft 74. The length of a tubular stem 82 of the handle 72 may be sufficiently long to permit a large range of length adjustments, such as between 4-10 inches total key length, for example. Alternatively, several shafts 74 of different lengths may be provided that can be coupled to the female end 76 using a locking pin 84, and to the handle using the set screw 80.

FIG. 9 is a perspective view of an ornamental handle 90 for the adjustable key 70 of FIGS. 7 and 8. That is, various handle styles may be provided and interchanged with a standard handle 72 purchased with the adjustable key 70.

While the invention has been described in its preferred embodiments, it is to be understood that the words which have been used are words of description and not of limitation. Therefore, changes may be made within the appended claims without departing from the true scope of the invention.

What is claimed is:

1. A gas valve assembly, comprising:
a gas valve including a valve control leg with male threading and a control stem passing therethrough;
a finishing flange having an axial extension with female threading; and
an adapter coupling the gas valve to the finishing flange, the adapter having an inner length with female threading adapted to mate with the male threading on a valve control leg, and an outer length with male threading adapted to mate with the female threading on the finishing flange.

2. The assembly of claim 1, wherein the gas valve assembly forms a part of a larger fireplace gas supply system.

3. The assembly of claim 1, wherein the male threading on the valve control leg, the female threading on the finishing flange, the female threading on the adapter inner length and the male threading on the adapter outer length are all parallel threading.

4. The assembly of claim 1, wherein the adapter is made of a metal selected from the group consisting of:
brass;
stainless steel; and
aluminum.

5. The assembly of claim 1, wherein the adapter is made of a suitably rigid plastic.

6. The assembly of claim 1, wherein the outer length is greater in axial dimension than the inner length.

7. The assembly of claim 7, wherein the total axial dimension of the adapter is about 6 inches.

8. The assembly of claim 7, wherein the axial dimension of the inner length is between about 1-2 inches.

9. A gas valve and key assembly, comprising:
a gas valve including a valve control leg with male threading and a control stem passing therethrough;
a finishing flange having an axial extension with female threading;
an adapter coupling the gas valve to the finishing flange, the adapter having an inner length with female threading adapted to mate with the male threading on a valve control leg, and an outer length with male threading adapted to mate with the female threading on the finishing flange; and
a gas key for controlling the gas valve having an adjustable length.

10. The assembly of claim 9, wherein the gas key includes a handle, a shaft, and a female end that mates with the gas valve, and the position of the handle on the shaft may be adjusted using a set screw.

11. The assembly of claim 9, wherein the gas key handle may be removed and replaced with a different style of handle.

12. A method of retrofitting a gas valve having a gas control leg with male parallel threading, comprising
threading a length adapter having female parallel threading onto the male parallel threading of the gas control leg of the gas valve; and
threading a finishing flange having female parallel threading onto male parallel threading of an outer length of the adapter.

13. The method of claim 12, wherein the gas valve forms a part of a fireplace gas supply system.

14. The method of claim 12, the adapter having an inner length with female threading adapted to mate with the male threading on a valve control leg, and an outer length with male threading adapted to mate with the female threading on the finishing flange, wherein the outer length is greater in axial dimension than the inner length.

15. The method of claim 14, wherein the total axial dimension of the adapter is about 6 inches.

16. The method of claim 14, wherein the axial dimension of the inner length is between about 1-2 inches.

17. The method of claim 14, further including:
adding to a wall or floor adjacent to fireplace having a gas supply system by constructing a new wall or floor over the existing wall or floor;
forming a hole in the new wall or floor at the location of a hole in the existing wall or floor within which is recessed the gas control leg of a gas valve.

18. The method of claim 17, the adapter having an inner length with female threading adapted to mate with the male threading on a valve control leg, and an outer length with male threading adapted to mate with the female threading on the finishing flange, wherein the outer length is greater in axial dimension than the inner length.

19. The method of claim 18, wherein the total axial dimension of the adapter is about 6 inches.

20. The method of claim 18, wherein the axial dimension of the inner length is between about 1-2 inches.
